(19) United States
(12) Patent Application Publication
(10) Pub. No.: US 2016/0216865 A1
(43) Pub. Date: Jul. 28, 2016

(54) APPLICATION USER PODS FOR APPLICATION KIOSK MODE

(71) Applicant: Google Inc., Mountain View, CA (US)

(72) Inventors: Alexander Friedrich KUSCHER, San Francisco, CA (US); Zelidrag HORNUNG, Los Gatos, CA (US); Vidya NAGARAJAN, Palo Alto, CA (US)

(21) Appl. No.: 14/604,626

(22) Filed: Jan. 23, 2015

(51) Int. Cl. G06F 3/0484; H04L 29/08; G06F 3/0481

(52) U.S. Cl. CPC G06F 3/04842; G06F 3/04817; H04L 67/10

(57) ABSTRACT

A device receives an indication to run on plural devices in a kiosk mode, wherein the indication identifies the application and indicates that the application is to be run in the kiosk mode on the device. A first graphical icon is displayed within a login screen on the device; the first graphical icon for initiating the application on the device in the kiosk mode. A second graphical icon is displayed within the login screen, the second graphical icon for logging into the device via a user profile. A user selection, corresponding to the first graphical icon or the second graphical icon, is received at the device. In a case where the received user selection corresponds to the first graphical icon, the application runs on the device in the kiosk mode. In a case where the received user selection corresponds to the second graphical icon, the user is logged into the device.

### FIELD

The present disclosure generally relates to a kiosk mode for an application and, in particular, running an application in kiosk mode.

### BACKGROUND

The kiosk mode for devices is often used in public places or commercial areas to provide interactive communication to end users of the devices. In kiosk mode, the devices typically run a single application and are locked down to block other applications from being launched. For example, kiosk mode can be used to limit a device to perform a specific task, communication, action or function (e.g., checking into an airline flight, where the flight check-in application is the only application permitted to run on the device). Kiosk mode can prevent misuse of the provided activities and can add a level of security by preventing end users from accessing desktop applications of the device.

In conventional approaches, devices used in kiosk mode are dedicated to running in kiosk mode only, and this can be an inefficient use of that device, since the device is locked to just one application. Furthermore, terminals used in kiosk mode may be configured on a per terminal basis, and this can be burdensome for an administrator to individually set up each terminal in the event a large number of devices are needed. Thus, it may be desirable to initiate kiosk mode in a more efficient and user-friendly manner.

### SUMMARY

The disclosed subject matter relates to a machine-implemented method for running an application in a kiosk mode. The method comprises receiving, at a device, an indication of an application to be run on plural devices in a kiosk mode, wherein the indication identifies the application and indicates that the application is to be run in the kiosk mode on the device. The method further comprises displaying a login screen on the device, and displaying a first graphical icon within the login screen, the first graphical icon for initiating the application on the device in the kiosk mode. The method further comprises displaying a second graphical icon within the login screen, the second graphical icon for logging into the device via a user profile, and receiving, at the device, user selection corresponding to the first graphical icon or the second graphical icon. The method further comprises running the application on the device in the kiosk mode, in a case where the received user selection corresponds to the first graphical icon.

The disclosed subject matter also relates to a system for running an application in a kiosk mode, the system comprising one or more processors and a machine-readable medium comprising instructions stored therein, which when executed by the processors, cause the processors to perform operations comprising receiving an indication of an application to be run on plural devices in a kiosk mode, wherein the indication identifies the application and indicates that the application is to be run in the kiosk mode on the system. The operations further comprise determining user identification in association with the application, creating an association between the user identification and the application to be run in kiosk mode, displaying a first graphical icon within the login screen, the first graphical icon for initiating the application on the system in the kiosk mode, and displaying a second graphical icon within the login screen, the second graphical icon for logging into the system via a user profile. The operations further comprise receiving a selection requesting access for a device of the plural devices in the kiosk mode and running the application on the device in the kiosk mode, based on the created association between the user identification and the application.

The disclosed subject matter further relates to a machine-readable medium comprising instructions stored therein, when the instruction is executed by the system, causes the system to perform operations comprising receiving, at a first device, user selection for an application to be run in a kiosk mode, receiving, at the first device, user selection of one or more second devices on which the application is to be run in the kiosk mode and providing for transmitting an indication of the application to each of the one or more second devices. The indication identifies the application, indicates that the application is to be run in the kiosk mode for each of the one or more second devices, and indicates a user identification that respectively associates users for each of the one or more second devices with the application. The application is configured to be run in the kiosk mode based on the user identification.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example network environment in which computing devices are configured to run in kiosk mode, according to aspects of the technology.

FIG. 2 illustrates an example login screen interface for running an application in kiosk mode or logging a user into a device, according to aspects of the technology.

FIG. 3 illustrates an example web portal interface for input by an administrator, according to aspects of the technology.

FIG. 4 illustrates an example process of running an application in a kiosk mode, according to aspects of the technology.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown at block diagram form in order to avoid obscuring the concepts of the subject technology.

In kiosk mode, devices typically run a single application and are locked down to block other applications from being launched. For example, kiosk mode can be used to limit a device to perform a specific task, communication, action or function. Kiosk mode can prevent misuse of the provided activities and can add a level of security by preventing end users from accessing desktop applications of the device. For example, in an exemplary embodiment, kiosk mode can be used to administer a software-based exam, where the exam is the only application permitted to run on the device). In another example, kiosk mode can be used for checking into an airline flight, where the flight check-in application is the only application permitted to run on the device. Kiosk mode can be used in semi-public (e.g., a standardized test exam room), public places or commercial areas to provide interactive communication to end users of the devices. Kiosk mode as described herein can be used for a variety of devices, including a desktop computer, a laptop, a tablet or a mobile phone.

The subject disclosure provides for an administrator to select an application (e.g., via a web portal for selecting applications) to be transmitted to plural devices in the kiosk mode. The plural devices can be designated by the administrator via the web portal, and the plural devices can be run in kiosk mode (e.g., to lock out all applications except the selected application) in response to the designation. An indication of the application can be transmitted to each of the devices by a server associated with the web portal.

In certain embodiments, the indication of the application is transmitted to the plural devices remotely through a network connection. In this manner, selection of the application by an administrator via a web portal may not be required. For example, the indication of the application can correspond to an application that is predetermined (e.g., as a default system setting, or a setting preselected by an end user or a network administrator).

The application can be subject to restrictions for running on the device. For example, the restrictions can include at least one of a start timeframe during which the application should be initiated, and a duration for which the application is permitted to run after being initiated. By way of non-limiting examples, the application can correspond to an examination administered to test-takers, a check-in application associated with a service or product, and/or a reservation application associated with a service or product. Additionally, the application can be server-based or cloud-based, where running the application corresponds to sending a request to a server or cloud infrastructure to run the application. Alternatively, or in addition, the application can be downloaded prior to running the application, and running the application can correspond to initiating the downloaded application on the device.

A user identification (e.g., login ID, Student ID or any other sort of an identification to identify the user) can be received in association with the application, and an association can be created between the user identification and the running of the application (e.g., to link students with the exams that they take, a user identification like an ID number may be received by the device in order to create an association between the kiosk application and the user running the application). By creating this association, for example, the administrator is able to manage the grading of exams linked to respective students.

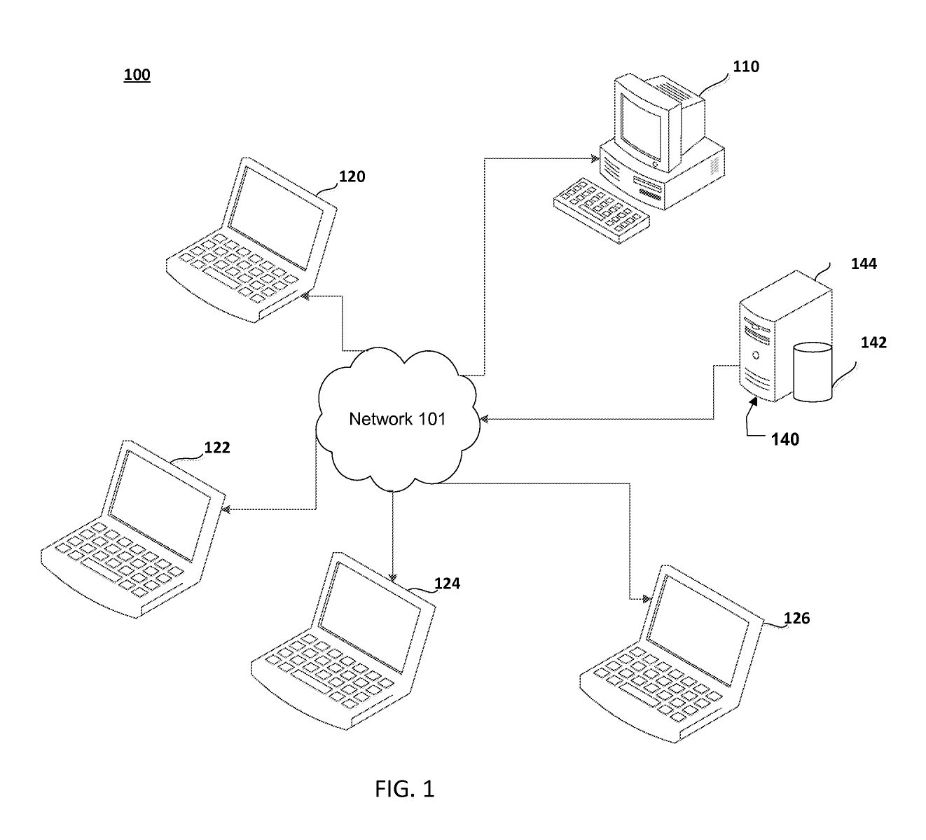

FIG. 1 illustrates an example network environment 100 in which computing devices are configured to run in kiosk mode, according to aspects of the technology. Network environment 100 includes computing devices 120, 122, 124 and 126 (hereinafter “120-126”), computing system 140 and web-based administration device 110. Computing devices 120-126, computing system 140 and web-based administration device 110 can communicate with each other through at least one network 101. Computing system 140 can include one or more computing devices 144 (e.g., one or more servers), and one or more computer-readable storage devices 142 (e.g., one or more databases).

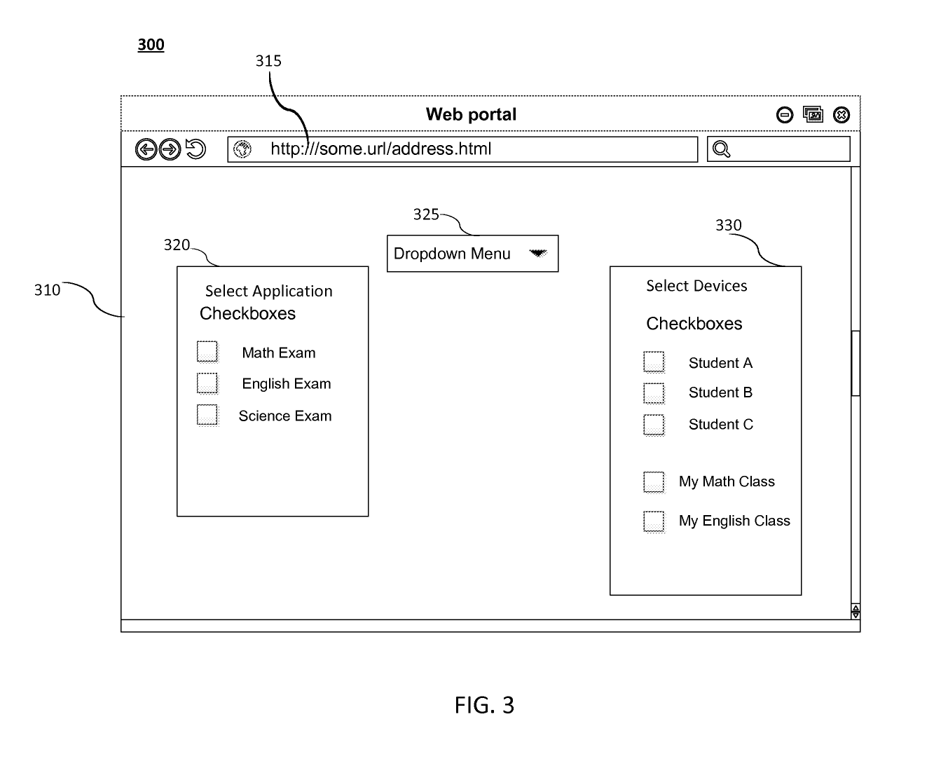

The web-based administration device 110 may be a computing device which accesses a web portal (e.g., web portal 310 of FIG. 3, described below), which can be used for transmitting applications (e.g., in kiosk mode) to computing devices 120-126 via network 101. Web portal can reside on a remote server (e.g., server 140 or a different server, not pictured). For example, an administrator or an authorized user at administration device 110 can access the web portal to select which application(s) to push to devices in kiosk mode, and which of computing devices 120-126 are to receive the application. In an example embodiment, the web portal functionality may be executed by instructions on the administration device 110 where no administrator is needed. As noted above, when the selected application is launched in kiosk mode, that application can be initiated from the login screen of the device (e.g., computing device 106) to run in kiosk mode (e.g., blocking out all other applications). In example aspects, the web portal allows the administrator to select from multiple options related to the application to run in kiosk mode. For example, the administrator may choose a certain application(s), set a start time for running the application (e.g., a timeframe during which an exam application is permitted to be launched), and/or a time out session related to the application once the session (e.g., exam) has started. Additionally, the administrator may choose the devices associated with that application either as individual devices (e.g., corresponding to individual students) or as plural devices (e.g., corresponding to an entire class, an entire school, an entire school district).

According to aspects of the technology, the administrator via the web portal may select users (e.g., instead of devices) to associate with the application in the kiosk mode. For example, in the case of administrated exams, the administrator may select students (e.g., by student name or identification number, or by designating a class in which the student list is already set) to associate them with specific applications to be run in kiosk mode, irrespective of the computing device the student uses. In this scenario, a student simply logs into any device within the classroom (e.g., as a default option), or outside the classroom (e.g., a home exam, if specified by the administrator via the web portal). If the student selects the kiosk mode application in the login screen, the device may request authentication information (e.g., username/student ID and password) from the student, before granting access to the kiosk mode application (e.g., exam).

The application may be a local application or a server-based (or cloud-based) application. The local application may be a packaged application that is downloaded by the computing device (e.g., any of 120-126), from a web or digital store that resides on server 140. An example of a packaged application is a native application downloaded from a server 144 onto computing device 120-126. Alternatively, or in addition, the local application maybe be downloaded manually onto the device via a digital interface such as a USB drive. Local applications reside on the computing device (e.g., any of 120-126) and may or may not require access to network 101 (e.g., to server 140) to run the application. For example, an exam may be run locally on the device, but may request access to network 101 to transfer test answers/results to the server upon completion of the exam.

On the other hand, server-based applications reside on server 140, and require computing device (e.g., any of 120-126) to access network 101 (e.g., server 140) to run the application. A server-based application may be an application that is configured to execute a single task or multiple tasks for a user on the computing device (e.g., any of 120-126) by accessing server 140 that hosts the server-based application. The server-based application may be configured to be executed or interpreted by a web browser or may be directly operating by an operating system in a kiosk mode. Thus, server-based applications can be programmed with web technologies and run with a dedicated user interface. Examples of server-based applications include software-based exams, games, photo editors, and certain video players that are run inside the browser.

Each of computing devices 120-126 can represent various forms of processing devices. Example processing devices can include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. Computing devices 120-126 and 144 may be provided access to or receive application software executed or stored on any of the other computing systems 120-126 and 144.

Computing device 144 may be any system or device having a processor, a memory, and communications capability for providing content to the electronic devices. In some example aspects, server 140 can be a single computing device, for example, a computer server. In other embodiments, server 140 can represent more than one computing device working together to perform the actions of a server computer (e.g., cloud computing). Further, computing device 144 can represent various forms of servers including, but not limited to a web server, an application server, a proxy server, a network server, a synchronization server, or a server farm.

In some aspects, the computing devices may communicate wirelessly through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, WiFi, or other such transceiver. In some aspects, network environment 100 can be a distributed client/server system that spans one or more networks, for example, network 101.

Network 101 can be a large computer network, for example, a local area network (LAN), wide area network (WAN), the Internet, a cellular network, or a combination thereof connecting any number of mobile clients, fixed clients, and servers. Further, the network 101 can include, but is not limited to, any one or more of the following network topologies, including a bus network, a star network, a ring network, a mesh network, a star-bus network, tree or hierarchical network, and the like. In some aspects, communication between each client (e.g., computing devices 120-126) and server (e.g., server 140) can occur via a virtual private network (VPN), Secure Shell (SSH) tunnel, or other secure network connection.

In example aspects, one or more of computing devices 120-126 receives an indication of an application selected by an administrator (e.g., at device 110 accessing the web portal) for pushing to the computing devices in a kiosk mode. The indication identifies the application and indicates that the application is to be run in the kiosk mode on the computing devices. The selected computing devices display a login screen, and display a first graphical icon within the login screen, where the first graphical icon is for initiating the application on the system in the kiosk mode. The selected computing devices also display a second graphical icon within the login screen, the second graphical icon for logging into the system via a user profile. The selected computing devices receive user selection corresponding to the first graphical icon or the second graphical icon. In a case where the received user selection corresponds to the first graphical icon, the respective computing device runs the selected application in the kiosk mode. In a case where the received user selection corresponds to the second graphical icon, the respective computing device logs the user into the device (e.g., in association with a user profile, for example, using a username and password entered by the user).

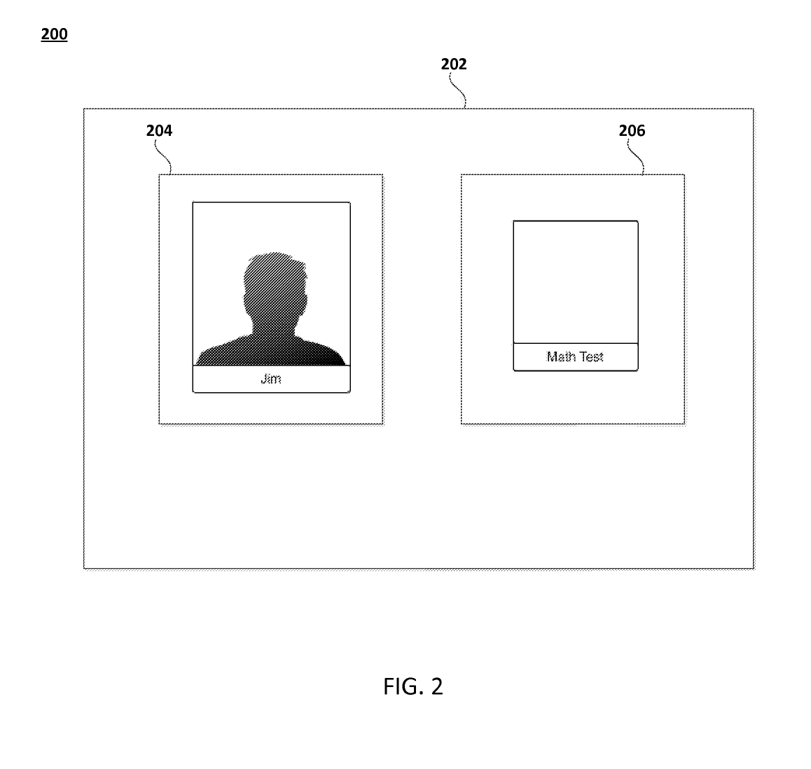

FIG. 2 illustrates an example login screen interface 200 for running an application in kiosk mode or logging a user into a device, according to aspects of the technology. The login screen interface 200 has a login screen 202 within the computing device (e.g., any of 120-126). The login screen 202 may have a kiosk mode application icon (e.g., “math test”) representing the first graphical icon 206 and a user profile login icon representing the second graphical icon 204. Although not shown in FIG. 2, the login screen 202 may have a number of different user login icons, e.g., a single computing device (e.g., any of 120-126) may be configured to allow user login by multiple users, where each user is represented with a user login icon that reflects a pre-defined user profile associated with the user. The user profile can be for logging into the computing device itself, or may be for logging the user into a network (e.g., a local network, the internet) or an on-line service. In addition, the login screen 202 may have more than one icon representing applications that run in a kiosk mode. For example, the login screen 202 may have multiple icons, each representing a different test (e.g. Math and English tests).

According to example aspects, the computing device user may select between the first graphical icon 206 and the second graphical icon 204. If the first graphical icon 206 is selected, the computing device (e.g., any of 120-126) runs the application associated with that selection in a kiosk mode, where the user is not allowed to access any other resources related in the computing device outside the running application. Alternatively or in addition, if the selection is for the second graphical icon, the computing device (e.g., any of 120-126) logs the user into the device via a pre-defined user profile. If the user selects graphical icon 206, the computing device (e.g., any of 120-126) may prompt the user for authentication information (e.g., a username and password or a user ID) prior to logging in, or may automatically log the user in (e.g., based on previously stored user-authorized authentication information).

If the user is logged into the device via a pre-defined user profile, upon selecting the second graphical icon 204, all user activities (e.g., access to applications and operating system settings) within the device are permitted, subject to the pre-defined rules associated with the user profile. In conventional cases, when a user selects the option to enter the device via a user profile, the user is granted access into most of the device resources, unless specified otherwise. For example, access to most of the device resources is permitted if the user profile corresponds to the owner/administrator of the computing device (e.g., any of 120-126), whereas access may be limited if the user is not the owner/administrator of that device.

According to example aspects of the technology, the computing device (e.g., any of 120-126) provides the user an option to log out of the device and log back into the computing device (e.g., any of 120-126) with no restrictions, if the user selection from the login screen corresponds to the second graphical icon 204 (e.g., when the user logs into the computing device via a pre-defined user profile). On the other hand, if the user selection from the login screen 202 is for the first graphical icon 206, the user may not have access to any resources beyond the authorized application in kiosk mode corresponding to first graphical icon 206 selection.

The computing device (e.g., any of 120-126) continues to run in kiosk mode until the application is timed out. For example, the duration for how long to run the application is preset and defined earlier by the administrator when the application to run in kiosk mode was selected. Another scenario for ending the session for a kiosk mode application is when the user decides to end the kiosk mode session, for example, by user input indicating to end the application (e.g., the user clicking an “exit” or “end and submit” interface or icon after he/she completes an exam). In either event, the user may not be allowed into the application in kiosk mode again unless the user is authorized to do so as specified by the administrator settings for that particular application.

In some aspects, when the user selection corresponds to the option of running the application in the kiosk mode, the computing device (e.g., any of 120-126) runs the application depending on the nature of the application, where the nature of the application is being a local application or a server-based application. If the application is a local application, the operating system of the computing device (e.g., any of 120-126) will run the application locally on the computing device. Once the kiosk session is completed (e.g., either by time out or due to the user opting to log out and exiting the application), the computing device (e.g., any of 120-126) may save the result of the user running the application in the kiosk mode and may provide updates to a server 140 in the event this is required for that application. In this manner, the administrator can later access the test results and follow up with students accordingly (e.g., via the web portal).

Alternatively, if the application to run in kiosk mode is a server-based application, the computing device (e.g., any of 120-126) will run the application by accessing hosting server 140 of the application. The computing device takes the necessary steps to maintain the network connection to ensure access to the hosting server 140 while the test is running and may request updates from the hosting server 140 during the run. Once the kiosk session is completed (e.g., either by time out or due to the user opting to log out and exiting the application), the server 140 may save the result of the user running the application in the kiosk mode. In this manner, the administrator can later access the test results and follow up with students accordingly (e.g., via the web portal).

For example with respect to both local and server-based applications, if the application to be run in a kiosk mode is a math exam, once the math exam is completed, the math exam results are saved and updates to the sever 140 related to this user and the session are provided by the computing device. The results provided by the computing device to the server 140 allow the administrator to further process these results, for example by grading the exam and pushing test results (e.g., via the web portal) along with correction/incorrect answers to the computing device for the user to look at it at a later time.

In example aspects, the computing device (e.g., any of 120-126) may monitor the connection with server 140, attempt to reconnect the computing device to the server in the event the connection with server 140 is lost. Furthermore, the computing device (e.g., any of 120-126) may need to save locally the activity of the kiosk mode session either to update the kiosk mode in the case the session is abruptly terminated or for providing server 140 with final results related to the kiosk mode session activity.

FIG. 3 illustrates an example web portal interface 300 for input by an administrator, according to aspects of the technology. The web portal interface 300 may include a web portal 310, which allows an authorized administrator, using a web-based administration device 110, to manage an application for administering in kiosk mode to all of computing devices 120-126 or a subset of computing devices 120-126. For example, the web portal 310 may be provided by server 140, and the applications to be run in kiosk mode reside on server 140. Alternatively, or in addition, the web portal may be hosted on a server which is separate from the server (e.g., server 140) on which the kiosk-mode applications reside.

The web portal 310 may provide an interface which includes, among other interface elements, a display area 315 within which a web page address is displayed. The web page has a uniform resource locator (“URL”) displayed within the display area 315, and the URL address corresponds to the address for a resource on a server (e.g., server 140). The web page includes form elements including a plurality of checkboxes (e.g., 320 and 330), a plurality of buttons (e.g., Math Exam, English Exam, Science Exam, Student A, Student B and Student C, My math class and My English class), and a dropdown menu 325.

According to aspects of the technology, an authorized administrator using the web portal 310 from a web-based administration device 110, may select a number of specific students. For example, by checking the check boxes Student A, Student B and Student C (e.g., corresponding to the names of individual students) within interface 330, the administrator can specify that these students are to take an exam. Alternatively or in addition, the administrator may choose a set of students by checking check boxes (e.g., My math class and/or My English class within interface 320). In another example, the administrator may select all check boxes, namely, Student A, Student B and Student C, My math class and/or My English class, indicating the selection of all students (e.g., all computing devices 120-126) within the network. In another example, the administrator may select a subset of the computing devices by only checking checkbox My math class.

Furthermore, the administrator may select the application(s) to run in kiosk mode, for pushing to the selected computing devices 120-126. For example, option 320 may correspond to a number of applications to run in Kiosk mode. To illustrate further, checkboxes Math exam, English exam and Science exam respectively are applications to be run in kiosk mode. The administrator may choose all checkboxes (e.g., Math exam, English exam, and science exam) or a subset of the boxes (e.g., Math exam). Once the administrator has selected the applications that need to be run in kiosk mode in option 320, these applications are then associated with the computing devices 120-126 (e.g., if assigned to particular students) or particular students (e.g., irrespective of which device they take the exam on) that have been selected from option 330. The administrator now has a set of computing devices or students that are associated with application(s) to run kiosk mode.

Additionally, the administrator may have an option to select from a dropdown menu 325 additional options related to the application in the kiosk mode. For example, the dropdown menu 325 may give the administrator an option to indicate if the application to run in kiosk mode has a duration (e.g., time limit) for the application to run. Additionally, the dropdown menu 325 may provide the administrator with an option to indicate a start time or date before which the application is not accessible to the user. The dropdown menu 325 may also provide an option allowing the end user of the application an option to run the application on a number of other devices (e.g., other computing devices within the class, or a home computing device), different than the device that the user initially used to access the kiosk mode application. The information selected by the administrator via the web portal is passed on to server 140 where the applications pushed into the computing devices 120-126 are configured accordingly.

In some example aspects, an administrator using the web portal 310 on the web-based administration device 110 has the option to select devices for kiosk mode on a large scale. For example, if the administrator is a teacher, he/she can use the web portal to select administering an exam or other application to all students in a single class of that teacher, or for all students in multiple classes of that teacher. In another example, if the administrator is a principal or district representative, the administrator can use the web portal to select administering the application (e.g., exam, student-wide form) to all students in a particular grade, school or school district.

Once devices are selected by the administrator, a request is sent from the web-based administration device 110 to a server 140. The request requires server 140 to push an indication to these selected device(s) 120. The indication includes information about an application that should be operated in a kiosk mode. As stated earlier, the application may be a local application or a server-based application.

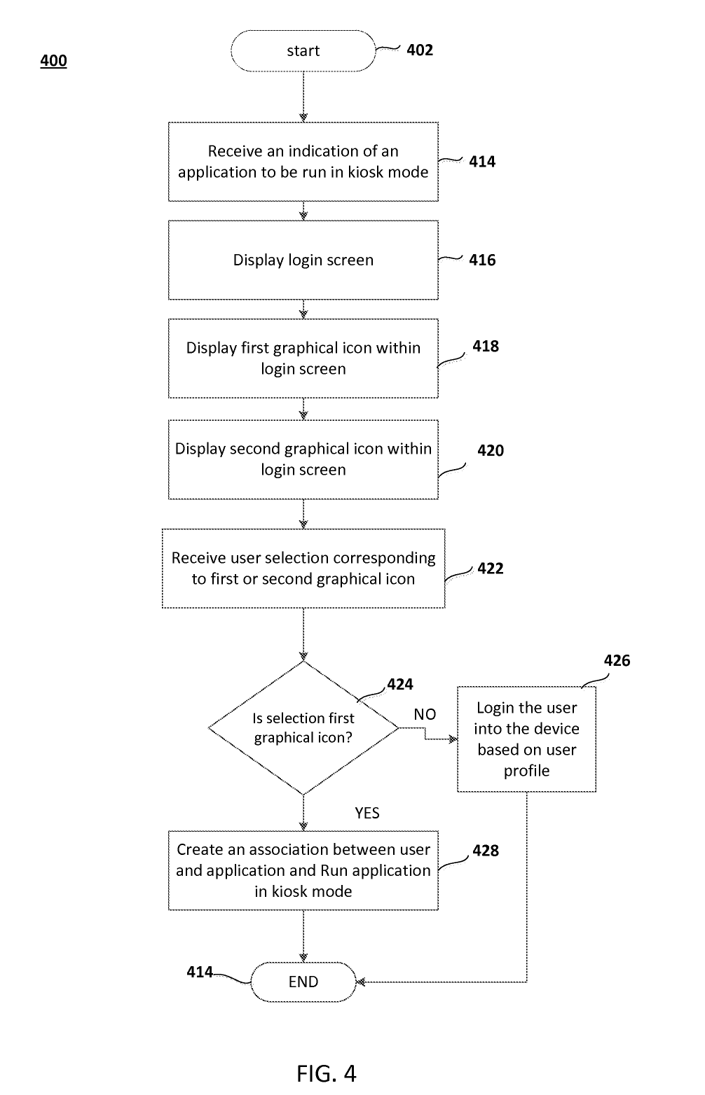

FIG. 4 illustrates an example process of running an application in a kiosk mode, according to aspects of the technology. For explanatory purposes, the blocks of the example process 400 are described herein as occurring in serial, or linearly. However, multiple blocks of the example process 400 may occur in parallel. In addition, the blocks of the example process 400 may be performed a different order than the order shown and/or one or more of the blocks of the example process 400 may not be performed. Further, while process 400 is discussed with reference to the systems in FIG. 1, it should be noted that process 400 is not limited to such and can apply to different systems and configurations.

In the example process 400, the computing device (e.g., any of 120-126) receives an indication of an application to be run in kiosk mode at block 414. The computing device (e.g., any of 120-126) receives the indication and takes the necessary steps to have the application ready to run when initiated by the user. Furthermore, the computing device (e.g., any of 120-126) displays a login screen at block 416. The login screen for example may be similar to the login screen of FIG. 2. The login screen 202 displays graphical icons at block 418, where the first graphical icon 206 is dedicated to the application that will be run in the kiosk mode. Additionally, the login screen displays a second graphical icon 204, where the second graphical icon is dedicated to an option to login the user of the computing device (e.g., any of 120-126) into the device (e.g., via a pre-defined user profile) at block 420. The same user may be logged into the computing device (e.g., any of 120-126) with either option of the graphical icons, where each option of the two graphical icons provides different rights and privileges within the machine based on the selected option.

The computing device (e.g., any of 120-126) receives a selection from a user, and that selection may correspond to either the first graphical icon or the second graphical icon at block 422. If the user selection is the second graphical icon 204, the computing device (e.g., any of 120-126) will log in the user into the device according to a pre-defined user profile at block 426. If the user selects graphical icon 206, the computing device (e.g., any of 120-126) may prompt the user for authentication information (e.g., a username and password) prior to logging in, or may automatically log the user in (e.g., based on previously stored user-authorized authentication information).

If the selection of the user is the first graphical icon 206, which represents an application to be run in kiosk mode, the computing device (e.g., any of 120-126) runs the application in kiosk mode. In example aspects of running the application in kiosk mode, the computing device determines a user identification in association with the application to be run in kiosk mode, creates an association between the user and the application, and runs the application in a kiosk mode based on the created association between the user identification and the application at block 428.

In example aspects, when running the application in kiosk mode, the computing device (e.g., any of 120-126) prompts the user (e.g., with one or more input boxes) for user identification via authentication information (e.g. user ID login and/or password, Student ID and password or a token that uniquely identifies that user), in order to run the application in association with the identification of the user.

Once an identification of the user is established, the computing device creates an association between the user and the application to be run in kiosk mode.

Using the test-taking scenario as an example, a student logs into the device using an ID (e.g., a username and/or password, a student ID), and this ID is associated with the application (e.g. a math exam) for running in kiosk mode. During or at the completion of the exam, the student's answers are stored in association with the exam. Further, results and/or grades for the exam are stored in association with the student (e.g., as identified by the ID) for further processing.

In a case where the exam is corresponds to a local application (e.g., downloaded from the server), the local application can determine whether the student's answers are correct or incorrect, and can determine a grade or other result for the student. Any one or more of the answers, results or grade can be transmitted to the server and associated with the student (e.g., using the ID). The grade or other result can be presented to the user at the completion of the exam, or may be provided to the student (e.g., using the same or a different computing device) by accessing the server at a later time, which may require re-authentication of the student using the ID.

In a case where the exam corresponds to a server-based application, any of the one or more of answers, results or grades can automatically be stored on the server in association with the student (e.g., using the ID). The grade or other result can be presented to the student by accessing the server, which may require re-authentication of the student using the ID.

As noted above, the user is not limited to a single computing device from which he/she can run an application in kiosk mode. For example, the user may run the application in kiosk mode on his/her classroom device, other class room devices that are not originally dedicated to him/her, or on a computing device at home (e.g., for administering take home exams). The devices (e.g., one or more classroom devices, home device) may be predetermined, for example, in association with a user profile which links a student to specific devices (e.g., a user's classroom and/or home device) or specific groups of devices (e.g., devices in a particular class).

In the event the application to be run and associated with the first graphical icon is a local application, the computing device runs the application from within the computing device (e.g., any of 120-126) in kiosk mode. In the event the application is a server-based (e.g., web) application, the computing device (e.g., any of 120-126) takes the necessary steps to connect to server 140 where the application resides and runs the application from server 140.

In some aspects, while the computing device is operating in kiosk mode, the computing device (e.g., any of 120-126) may automatically update the server-based application, via network 101. For example, the computing device (e.g., via its operating system) may periodically query server 140 to determine whether the application has any updates available for installation. Such a query may be done automatically, and without user input or the display of any user interface. The computing device (e.g., any of 120-126) may then push any updates to the application, again without user input, and in some implementations, without displaying any user interface or notification.

The computing device (e.g., any of 120-126) may also automatically update its operating system via a network while the computer is operating in kiosk mode. Such updating may be performed on a periodic basis by the operating system of the computing device (e.g., any of 120-126), or in response to the operating system receiving a pushed update from server 140. A pushed update from the server 140, maybe a scheduled periodic update, for example quarterly update. Once the application is initially pushed into the computing device, the application icon may reside locally on the computing device unless it has been deliberately erased from the computing device. For example, if the application is a Math exam application the user will not have access to this application unconditionally, despite the fact that it resides on his computing device for the application might have a restriction on what time and date exactly the user is able to run the application. Furthermore, the application will be updated periodically by the server 140 by pushing new updates or completely new exams for future use for example.

The computing device (e.g., any of 120-126) may monitor the state of the application while in kiosk mode, and the computing device may thus detect an interrupted status of the web-server based application, for example if the server-based application crashes unexpectedly while in a session. If the computer detects an interrupted status of the server-based application, the computer may automatically re-launch the server-based application, for example using the operating system to automatically re-boot the computer and launch in the kiosk mode such that the application is executing at the same point where it was before it crashed. Such automatic re-launching may be performed by the operating system of the computer device without requiring user input.

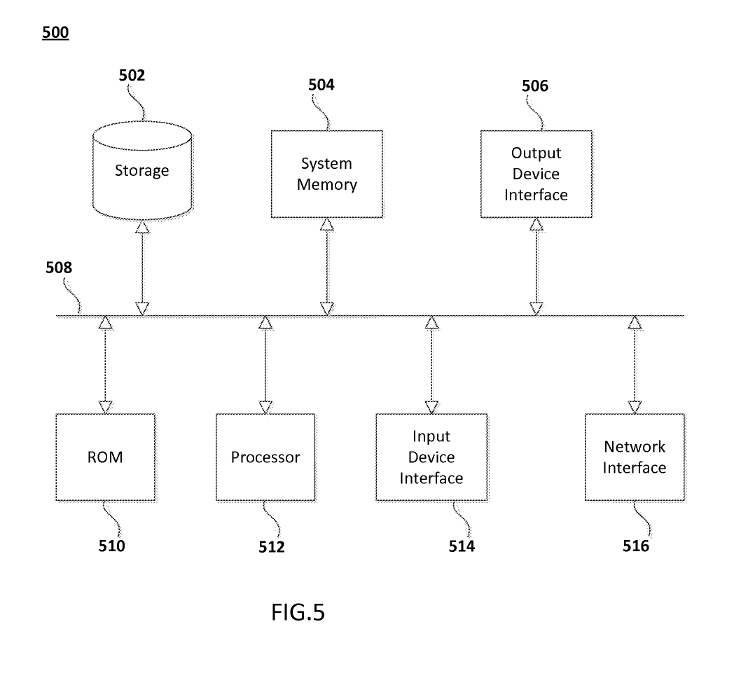

FIG. 5 conceptually illustrates a computing system 500 with which implementations of the subject technology, such as server 112 and wireless client device (e.g., any of 120-126), may be implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processor 512, a system memory 504, a read-only memory (ROM) 510, a permanent storage device 502, an input device interface 514, an output device interface 506, and a network interface 516.

Bus 508 collectively represents system, peripheral, and chipset buses that communicatively connect the numerous internal devices of electronic system 500. For instance, bus 608 communicatively connects processor 512 with ROM 510, system memory 504, and permanent storage device 502.

From these various memory units, processor 512 retrieves instructions to execute and data to process in order to execute the processes of the subject disclosure. The processor can be a single processor or a multi-core processor in different implementations.

ROM 510 stores static data and instructions that are needed by processor 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for running an application in a kiosk mode according to various implementations. From these various memory units, processor 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more” unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A machine-implemented method for running an application in a kiosk mode, the method comprising:
receiving, at a device, an indication of an application to be run on plural devices in a kiosk mode, wherein the indication identifies the application and indicates that the application is to be run in the kiosk mode on the device;
displaying a login screen on the device;
displaying a first graphical icon within the login screen, the first graphical icon for initiating the application on the device in the kiosk mode;
displaying a second graphical icon within the login screen, the second graphical icon for logging into the device via a user profile;
receiving, at the device, user selection corresponding to the first graphical icon or the second graphical icon; and
running the application on the device in the kiosk mode, in a case where the received user selection corresponds to the first graphical icon.

2. The method of claim 1, further comprising:
logging into the device via the user profile, in a case where the received user selection corresponds to the second graphical icon.

3. The method of claim 1, wherein the indication of the application corresponds to a selection of the application via a web portal for selecting applications to be run on the plural devices in the kiosk mode.

4. The method of claim 3, wherein the plural devices are selected via the web portal, and wherein access to the application is limited to the plural devices.

5. The method of claim 3, wherein the indication of the application is transmitted to the device by a server associated with the web portal.

6. The method of claim 1, wherein the application is subject to restrictions for running on the device, the restrictions including at least one of a start timeframe during which the application should be initiated, and a duration for which the application is permitted to run after being initiated.

7. The method of claim 1, wherein the application corresponds to at least one of an examination administered to test-takers, a check-in application associated with a service or product, or a reservation application associated with a service or product.

8. The method of claim 1, wherein the application is server-based, and the running comprises sending a request to a server to run the application.

9. The method of claim 1, further comprising:
downloading the application prior to running the application, wherein the running comprises initiating the downloaded application on the device.

10. The method of claim 1, further comprising:
receiving a user identification in association with the application; and
creating an association between the user identification and the running of the application.

11. A system for running an application in a kiosk mode, the system comprising:
one or more processors; and
a machine-readable medium comprising instructions stored therein, which when executed by the processors, cause the processors to perform operations comprising:
receiving an indication of an application to be run on plural devices in a kiosk mode, wherein the indication identifies the application and indicates that the application is to be run in the kiosk mode on the system;
determining a user identification in association with the application;
creating an association between the user identification and the application to be run in the kiosk mode;
displaying a first graphical icon within the login screen, the first graphical icon for initiating the application on the system in the kiosk mode;
displaying a second graphical icon within the login screen, the second graphical icon for logging into the system via a user profile;
receiving a selection requesting access for a device of the plural devices in the kiosk mode; and
running the application on the device in the kiosk mode, based on the created association between the user identification and the application;

12. The system of claim 11, wherein the indication of the application corresponds to a selection of the application via a web portal for selecting applications to be run on the plural devices in the kiosk mode.

13. The system of claim 12, wherein the plural devices are selected via the web portal, and wherein access to the application is limited to the plural devices.

14. The system of claim 12, wherein the indication of the application is transmitted to the system by a server associated with the web portal.

15. The system of claim 11, wherein the application is subject to restrictions for running on the system, the restrictions including at least one of a start timeframe during which the application should be initiated, and a duration for which the application is permitted to run after being initiated.

16. The system of claim 11, wherein the application corresponds to at least one of an examination administered to test-takers, a check-in application associated with a service or product, or a reservation application associated with a service or product.

17. A machine-readable medium comprising instructions stored therein, which when executed by a system, cause the system to perform operations comprising:
receiving, at a first device, user selection of an application to be run in a kiosk mode;
receiving, at the first device, user selection of one or more second devices on which the application is to be run in the kiosk mode; and
providing for transmitting an indication of the application to each of the one or more second devices,
wherein the indication identifies the application, indicates that the application is to be run in the kiosk mode for each of the one or more second devices, and indicates a user identification that respectively associates users for each of the one or more second devices with the application, and
wherein the application is configured to be run in the kiosk mode based on the user identification.

18. The machine-readable medium of claim 17, further comprising:
displaying a user interface for selecting the application and for selecting the one or more second devices,
wherein the user selection of the application and the user selection of the one or more second devices are received via the displayed user interface, and
wherein the displayed user interface is associated with a web portal.

19. The machine-readable medium of claim 17, wherein access to the application is limited to the one or more second devices.

20. The machine-readable medium of claim 17, further comprising:
receiving, at the first device, one or more restrictions for running the application on the one or more second devices, the one or more restrictions including at least one of a start timeframe during which the application should be initiated, and a duration for which the application is permitted to run after being initiated.
